(19) United States
(12) Patent Application Publication
(10) Pub. No.: US 2022/0216568 A1
(43) Pub. Date: Jul. 7, 2022

(54) IMPROVED COATED BATTERY SEPARATOR

(71) Applicant: Celgard, LLC, Charlotte, NC (US)

(72) Inventors: Stefan Reinartz, Waxhaw, NC (US); Katharine Chemelewski, Campbell, CA (US); Barry j. Summey, Clover, SC (US); Robert Moran, Concord, NC (US)

(21) Appl. No.: 17/613,113

(22) PCT Filed: May 22, 2020
(86) PCT No.: PCT/US2020/034117

§ 371 Date: Nov. 22, 2021

Related U.S. Application Data
(60) Provisional application No. 62/852,355, filed on May 24, 2019.
(60) Provisional application No. 62/857,585, filed on Jun. 5, 2019.

(51) Int. Cl. H01M 50/403; H01M 50/434; H01M 50/494; H01M 50/457

(52) U.S. Cl. CPC H01M 50/403; H01M 50/457; H01M 50/494; H01M 50/434

(57) ABSTRACT

A coated battery separator is described herein. The coated battery separator includes a porous membrane with a coating on at least one side thereof, wherein the coated separator exhibits at least one of improved thickness uniformity of the coating and improved adhesion of the coating to the porous membrane. In some embodiments, the coated battery separator is thin or ultrathin. A method for forming a coated battery separator that exhibits the aforementioned properties is also described. The method may include steps of forming a coating and calendering the coating. In some embodiments, calendering is performed on a dried coating. In some embodiments, the coating is or includes a ceramic coating, a polymer coating, a sticky coating, a shutdown coating, or combinations thereof.

### CROSS-REFERENCE TO RELATED APPLICATIONS

The present application is a 371 U.S. Application of PCT/US2020/034117, filed May 22, 2020, which claims priority to and the benefit of U.S. provisional patent application Ser. Nos. 62/852,355, filed May 24, 2019, and 62/857,585, filed Jun. 5, 2019, both hereby fully incorporated by reference herein.

### FIELD

This application is directed to improved battery separators, and particularly to improved coated battery separators. In some embodiments, the battery separator may be a thin or ultrathin battery separator.

### BACKGROUND

Increasing performance standards, safety standards, manufacturing demands, and/or environmental concerns make the development of new coated battery separators desirable. Particularly, there is a demand for t Increasing performance standards, safety standards, manufacturing demands, and/or environmental concerns thinner battery separators. A thinner battery separator may be used to form a battery having the same overall thickness, but a higher energy density. This is desirable.

It is also desirable to form battery separators with coatings, including ceramic coatings, which may block the growth of lithium dendrites and help to prevent shorts caused by these dendrites. These improve the safety of the battery separator. However, one drawback of typical coatings is that they add thickness. Typically, about 1 nm of thickness or more is added to the battery separators when a coating is supplied. Thus, the formation of thin or ultrathin coated battery separators is also desirable.

### SUMMARY OF THE INVENTION

In one aspect, a method for forming a coated separator is described. In some embodiments, the coated separator formed by this method may be a thin or ultrathin coated separator. Thin coated separators may have a thickness of 1 to 18 or 1 to 12 microns or 12 or 18 microns or less, and an ultrathin coated separator may have a thickness of 1 to 11 microns, 1 to 9 microns or 9 microns or less. In some embodiments, the method described herein comprises the following steps: (1) forming a coating on at least one side of a porous membrane to form a coated porous membrane; and (2) calendering the coated porous membrane to obtain a coated and calendered porous membrane. The coated and calendered porous membrane is used to form the thin or ultrathin coated battery separator. The thin or ultrathin coated battery separator may comprise, consist of, or consist essentially of the coated and calendered porous membrane.

In some embodiments, the step of forming a coating on at least one side of the porous membrane may comprise forming a coating on one side or on both sides. In embodiments where a coating is formed on both sides of the porous membrane, the coatings may be the same or different. Coatings may comprise, consist of, or consist essentially of a ceramic coating, a polymer coating, a shutdown coating, a sticky coating, and combinations thereof. A ceramic coating may comprise, consist of, or consist essentially of ceramic and a binder. In some embodiments, a coating formed may comprise, consist of, or consist essentially of a ceramic coating. The ceramic coating may comprise, consist of, or consist essentially of 60% or more ceramic, 70% or more ceramic, 80% or more ceramic, 90% or more ceramic, or 95% or more ceramic based on the total coating solids. Before calendering, the coating may have a thickness of from 0.5 to 10 microns or preferably from 1 to 5 microns.

In some embodiments, the method for forming a coated separator as described herein may include a calendering step that is performed on a dried coating. In some steps calendering involves the application of heat and/or pressure. In some embodiments, the calender is placed in direct contact with the coating, and in other embodiments, it may be placed in indirect contact. Calendering may involve applying force of up to 300 or up to 250 lbs/linear inch of web width and/or heat of 20 degrees Celsius to 100 degrees Celsius or 25 degrees Celsius to 90 degrees Celsius, or 25 degrees Celsius to 80 degrees Celsius, or 25 degrees Celsius to 75 degrees Celsius.

In some embodiments, the porous membrane herein may be a microporous membrane. In some embodiments, the porous membrane may be a wet process porous membrane, a dry process porous membrane, or a dry-stretch process porous membrane.

In another aspect, a coated battery separator made by the method described herein is described. The coated battery separator may be a thin or ultrathin coated battery separator.

In another aspect, a secondary battery comprising the coated battery separator made by the method described herein is described. The secondary battery may comprise the thin or ultrathin coated battery separator described herein.

In another aspect, a coated battery separator comprising, consisting of, or consisting essentially of a porous membrane with a coating on at least one side thereof, wherein the coated separator exhibits at least one of improved thickness uniformity of the coating and improved adhesion of the coating to the porous membrane. In some embodiments, the coated battery separator may be a thin or ultrathin coated battery separator. The coated battery separator may have a thickness from 1 to 30 microns. A thin battery separator may have a thickness from 1 to 12 microns or 12 microns or less. An ultrathin battery separator may have a thickness from 1 to 9 microns or 9 microns or less.

In some embodiments, the porous membrane herein may be a microporous membrane. In some embodiments, the porous membrane may be a wet process porous membrane, a dry process porous membrane, or a dry-stretch process porous membrane. The thin or ultrathin coated battery separator of claim 30, wherein the porous membrane is a microporous membrane.

In some embodiments, the coating may be provided on one or both sides of the porous membrane. In embodiments where a coating is formed on both sides of the porous membrane, the coatings may be the same or different. Coatings may comprise, consist of, or consist essentially of a ceramic coating, a polymer coating, a shutdown coating, a sticky coating, and combinations thereof. A ceramic coating may comprise, consist of, or consist essentially of ceramic and a binder.

In another aspect, a secondary battery comprising the coated battery separator described herein is described. The coated battery separator may be thin or ultrathin.

### DESCRIPTION OF THE FIGURES

FIGS. 1-20 include tables and graphs including data for some embodiments described herein.

FIGS. 21-23 include cross-section SEMs of some embodiments described herein.

FIG. 24 is a schematic drawing showing a film web going through calendering rolls, which are designated by the curved arrows.

### DESCRIPTION OF THE INVENTION

Described herein is an improved coated separator and a method for making the same. The coated separator may comprise, consist of, or consist essentially of a porous membrane and a coating on one or both sides thereof. In some embodiments, the coated separator exhibits at least one of improved coating uniformity and improved adhesion of the coating to the microporous membrane, among other beneficial properties. In some embodiments, the coated separator may be a thin or ultrathin coated separator. In some embodiments, the coating may comprise or be at least one of a ceramic coating, a polymer coating, a sticky coating, a shutdown coating, and combinations thereof.

The method for forming a coated separator as described herein may include (1) forming a coating on one or both sides of a porous membrane to obtain a coated porous membrane, and (2) calendering the coated porous membrane to form a calendered coated porous membrane. The coated separator may comprise, consist of, or consist essentially of the calendered and coated porous membrane. In some embodiments, calendering may be performed on a dried coating.

Also described is a secondary battery separator comprising a coated battery separator as described herein or comprising a coated battery separator made by the method described herein.

This is described in further detail herein below.

### Method

A method described herein comprises at least the steps of (1) forming a coating on at least one side of a porous membrane to obtain a coated porous membrane, and (2) calendering the coated porous membrane to obtain a coated and calendered porous membrane. The method may also include steps before the first step (1), after the first step (1), before the second step (2), or after the second step (2). In some embodiments, calendering was performed on a dried coating.

The porous membrane may be a microporous, nanoporous, or macroporous membrane in some embodiments. In some embodiments, the microporous membrane may be formed by a dry process, including a dry-stretch process, or a wet process. In some preferred embodiments, the porous membrane may be a microporous membrane formed by a dry-stretch process. A dry-stretch process may include the steps of: extruding a non-porous precursor, annealing the non-porous precursor, and stretching the nonporous precursor to form pores. Stretching may be performed in the MD direction, in the TD direction or in both the MD and TD direction.

The porous membrane is preferably a polymeric porous membrane. The choice of polymer is not so limited, but in preferred embodiments, the porous membrane may comprise, consist of, or consist essentially of a polyolefin.

(1) Forming a Coating on at Least One Side of the Porous Membrane

How the coating is formed is not so limited. Any known method for forming a coating may be used. This may include, but is not limited to vapor deposition, physical vapor deposition, chemical and electrochemical techniques, spraying, roll-to-roll coating processes (air knife or gravure for example), and physical coating processes (e.g., dip coating or spin coating).

The coating is not so limited, and any battery separator coating may be used. In some embodiments, the coating may be or include at least one selected from the group consisting of a ceramic coating, a polymer coating, a sticky coating, a shutdown coating, and combinations thereof.

In some preferred embodiments, the coating may be a ceramic coating. For example, the ceramic coating may be a ceramic coating as described in U.S. Pat. Nos. 6,432,586, 9,985,263 or PCT Application No. PCTUS2017043266, which are incorporated herein by reference in its entirety. A ceramic coating may comprise, consist of, or consist essentially of a ceramic material, a binder, and an optional solvent. The ceramic coating may comprise at least 10% ceramic, at least 20% ceramic, at least 30% ceramic, at least 40% ceramic, at least 50% ceramic, at least 60% ceramic, at least 70% ceramic, at least 80% ceramic, at least 90% ceramic, at least 95% ceramic, or at least 98% or 99% ceramic based on the total coating solids.

The ceramic is not so limited. Any ceramic not inconsistent with the stated goals herein may be used. Any heat resistant material may be used as the ceramic material. The size, shape, chemical composition, etc. of these heat-resistant particles is not so limited. The heat-resistant particles may comprise an organic material, an inorganic material, e.g., a ceramic material, or a composite material that comprises both an inorganic and an organic material, two or more organic materials, and/or two or more inorganic materials.

In some embodiments, heat-resistant means that the material that the particles are made up of, which may include a composite material made up of two or more different materials, does not undergo substantial physical changes, e.g., deformation, at temperatures of 200° C. Exemplary materials include aluminum oxide (Al₂O₃), silicon dioxide (SiO₂), graphite, etc.

Non-limiting examples of inorganic materials that may be used to form the heat-resistant particles disclosed herein are as follows: iron oxides, silicon dioxide (SiO₂), aluminum oxide (Al₂O₃), boehmite (Al(O)OH), zirconium dioxide (ZrO₂), titanium dioxide (TiO₂), barium sulfate (BaSO₄), barium titanium oxide (BaTiO₃), aluminum nitride, silicon nitride, calcium fluoride, barium fluoride, zeolite, apatite, kaoline, mullite, spinel, olivine, mica, tin dioxide (SnO₂), indium tin oxide, oxides of transition metals, graphite, carbon, metal, and any combinations thereof.

Non-limiting examples of organic materials that may be used to form the heat-resistant particles disclosed herein are as follows: a polyimide resin, a melamine resin, a phenol resin, a polymethyl methacrylate (PMMA) resin, a polystyrene resin, a polydivinylbenzene (PDVB) resin, carbon black, graphite, and any combination thereof.

The heat-resistant particles may be round, irregularly shaped, flakes, etc. The average particle size of the heat-resistant material ranges from 0.01 to 5 microns, from 0.03 to 3 microns, from 0.01 to 2 microns, etc.

The binder used in the coating is not so limited. Any binder not inconsistent with the stated goals herein may be used.

In some embodiments, the binder may be water (e.g., for a water-based coating) or an acrylic. In some embodiments, the binder may be a polymeric binder comprising, consisting of, or consisting essentially of a polymeric, oligomeric, or elastomeric material and the same are not limited. Any polymeric, oligomeric, or elastomeric material not inconsistent with this disclosure may be used. The binder may be ionically conductive, semi-conductive, or non-conductive. Any gel-forming polymer suggested for use in lithium polymer batteries or in solid electrolyte batteries may be used. For example, the polymeric binder may comprise at least one, or two, or three, etc. selected from a polylactam polymer, polyvinyl alcohol (PVA), Polyacrylic acid (PAA), Polyvinyl acetate (PVAc), carboxymethyl cellulose (CMC), an isobutylene polymer, an acrylic resin, latex, an aramid, or any combination of these materials.

In some preferred embodiments, the polymeric binder comprises, consists of, or consists essentially of a polylactam polymer, which is a homopolymer, co-polymer, block polymer, or block co-polymer derived from a lactam. In some embodiments, the polymeric material comprises a homopolymer, co-polymer, block polymer, or block co-polymer according to formula (1).

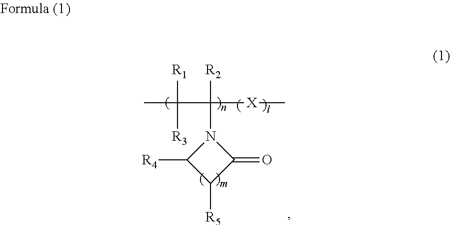

wherein R₁, R₂, R₃, and R₄ can be alkyl or aromatic substituents and R₅ can be an alkyl substituent, an aryl substituent, or a substituent comprising a fused ring; and wherein the preferred polylactam can be a homopolymer or a co-polymer where co-polymeric group X can be derived from a vinyl, a substituted or un-substituted alkyl vinyl, a vinyl alcohol, vinyl acetate, an acrylic acid, an alkyl acrylate, an acrylonitrile, a maleic anhydride, a maleic imide, a styrene, a polyvinylpyrrolidone (PVP), a polyvinylvalerolactam, a polyvinylcaprolactam (PVCap), polyamide, or a polyimide; wherein m can be an integer between 1 and 10, preferably between 2 and 4, and wherein the ratio of l to n is such that 0≤l:n≤10 or 0≤l:n≤1. In some preferred embodiments, the homopolymer, co-polymer, block polymer, or block co-polymer derived from a lactam is at least one, at least two, or at least three, selected from the group consisting of polyvinylpyrrolidone (PVP), polyvinylcaprolactam (PVCap), and polyvinyl-valerolactam.

In another preferred embodiment, the polymeric binder comprises, consists of, or consists essentially of polyvinyl alcohol (PVA). Use of PVA may result in a low curl coating layer, which helps the substrate to which is it applied stay stable and flat, e.g., helps prevent the substrate from curling. PVA may be added in combination with any other polymeric, oligomeric, or elastomeric material described herein, particularly if low curling is desired.

In another preferred embodiment, the polymeric binder may comprise, consist of, or consists essentially of an acrylic resin. The type of acrylic resin is not particularly limited, and may be any acrylic resin that would not be contrary to the goals stated herein, e.g., providing a new and improved coating composition that may, for example, be used to make battery separators having improved safety. For example, the acrylic resin may be at least one, or two, or three, or four selected from the group consisting of polyacrylic acid (PAA), polymethylmethacrylate (PMMA), polyacrylonitrile (PAN), polymethyl acrylate (PMA).

In other preferred embodiments, the polymeric binder may comprise, consist of, or consist essentially of carboxymethyl cellulose (CMC), an isobutylene polymer, latex, or any combination these. These may be added alone or together with any other suitable oligomeric, polymeric, or elastomeric material.

In some embodiments, the polymeric binder may comprise a solvent that is water only, an aqueous or water-based solvent, and/or a non-aqueous solvent. When the solvent is water, in some embodiments, no other solvent is present. The aqueous or water-based solvent may comprise a majority (more than 50%) water, more than 60% water, more than 70% water, more than 80% water, more than 90% water, more than 95% water, or more than 99%, but less than 100% water. The aqueous or water-based solvent may comprise, in addition to water, a polar or non-polar organic solvent. The non-aqueous solvent is not limited and may be any polar or non-polar organic solvent compatible with the goals expressed in this application. In some embodiments, the polymeric binder comprises only trace amounts of solvent, and in other embodiments it comprises 50% or more solvent, sometimes 60% or more, sometimes 70% or more, sometimes 80% or more, etc.

The amount of binder, in some preferred embodiments, may be less than 20%, less than 15%, less than 10%, or less than 5% of the total solids in the coating. In some particularly preferred embodiments, the amount of binder may be 10% or less, or 5% or less of the total solids in the coating.

A polymer coating as described herein is not so limited, and may be any polymer coating not inconsistent with the stated goals herein. For example, the polymer coating may be any polymer coating used or suitable for use on a battery separator. For example an acrylic polymer coating may be used.

A sticky coating as described herein is not so limited, and may be any sticky coating not inconsistent with the stated goals herein. In some embodiments, the sticky coating may be one that increases adhesion of the battery separator to an electrode in a dry (before electrolyte is added) and/or wet (after electrolyte is added) environment. For example, a sticky coating may comprise, consist of, or consist essentially of PVDF.

A shutdown coating as described herein is not so limited, and may be any shutdown coating not inconsistent with the stated goals herein. A shutdown coating may be one that causes the battery separator to shutdown once temperatures increase beyond a certain threshold. For example, the material of the shutdown coating may melt and fill or partially fill the pores of the porous membrane stopping or slowing ionic flow across the separator. For example, a shutdown coating may comprise, consist of, or consist essentially of a low density polyethylene.

In some embodiments, the formed coating may have a thickness from 0.1 to 10 microns, preferably from 0.1 to 5 microns. This is the thickness prior to calendering and/or after drying. The thickness may decrease from 1 to 50% after calendering.

After forming the coating, the coating may be dried before calendering. Any method may be used to dry the coating, including air drying and drying in an oven/

(2) Calendering the Porous Membrane

The calendering described herein is not so limited and any calendering method not inconsistent with the stated goals herein may be used. In some embodiments, calendering may involve the application of at least one of heat, pressure, or a combination of heat and pressure. In some embodiments, calendering may be performed using a calendering instrument. For example, a calendering roll may be used. The calendering instrument may be placed in direct or indirect contact with the coating during calendering. Indirect contact means that something is placed between the calendering instrument and the coating. For example, something may be placed in between the calendering instrument and the coating to protect the coating.

The calendering pressure is not so limited. For example, in some embodiments a force of up to 350, 325, 300, 275, 250, 225, or 200 lbs/inch width of the calendering device. A minimum calendering pressure of 0.6 MPa and a maximum of 7 MPa may be acceptable. Also a range of 0.78 to 5 MPa is acceptable.

The calendering temperature is also not so limited. For example, an exemplary temperature range is from 20 to 100 C, from 25 to 90 C, from 25 to 80 C, from 25 to 75 C, from 25 to 70 C, or from 25 to 60 C. Preferably, calendering temperatures do not deform the membrane or coating.

In embodiments where two coatings are formed on the porous film, calendering may be performed on one or both of the coatings.

### Coated Separator

The coated separator described herein may be any coated separator formed by the method described hereinabove.

In some embodiments, the coated separator comprises a porous membrane, e.g., one as described herein, and a coating, e.g., one as described herein, on one or both sides thereof. One or both of the coatings may have been calendered. The coated separator may exhibit at least one of the following properties improved thickness uniformity of the coating, improved adhesion of the coating to the porous membrane, increased mixed-p(N), reduced amount of coating that comes off with rubbing, increased MD tensile stress (kgf/cm²), and increased TD tensile stress (kgf/cm²). These changes are compared to a coated separator that has not been calendered. For example, mixed-P(N) may be greater than 850N, greater than 900N, greater than 950N, or greater than 1000N. MD tensile stress may be greater than 1600 kgf/cm², greater than 1700 kgf/cm², greater than 1800 kgf/cm², greater than 1900 kgf/cm², or greater than 2000 kgf/cm². TD tensile stress (kgf/cm²) may be greater than 80, 90, 100, 110, 120, or 130. Peelable force (mg/cm²) may be greater than 110, 114 or 115. Shutdown speed (Ω-cm²/sec) greater than 3500, greater than 4000, greater than 5000, greater than 6000, greater than 7000.

For example, the thickness uniformity, expressed as thickness standard deviation may be less than ±0.3 microns, less than ±0.4 microns, less than ±0.5 microns, less than ±0.6 microns, less than ±0.7 microns, or less than ±0.8 microns.

### Device

Any secondary battery may be used. In some examples, the secondary battery may comprise an anode, a cathode, and at least one separator as described herein between an anode and a cathode.

Any capacitor may be used and the capacitor may comprise a battery separator as described herein.

### EXAMPLES

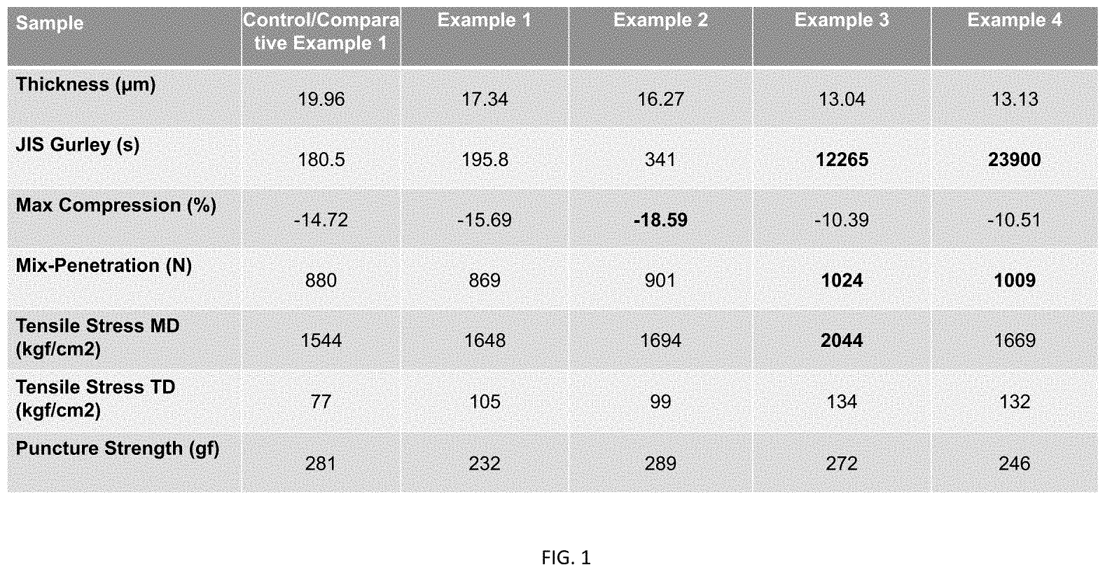

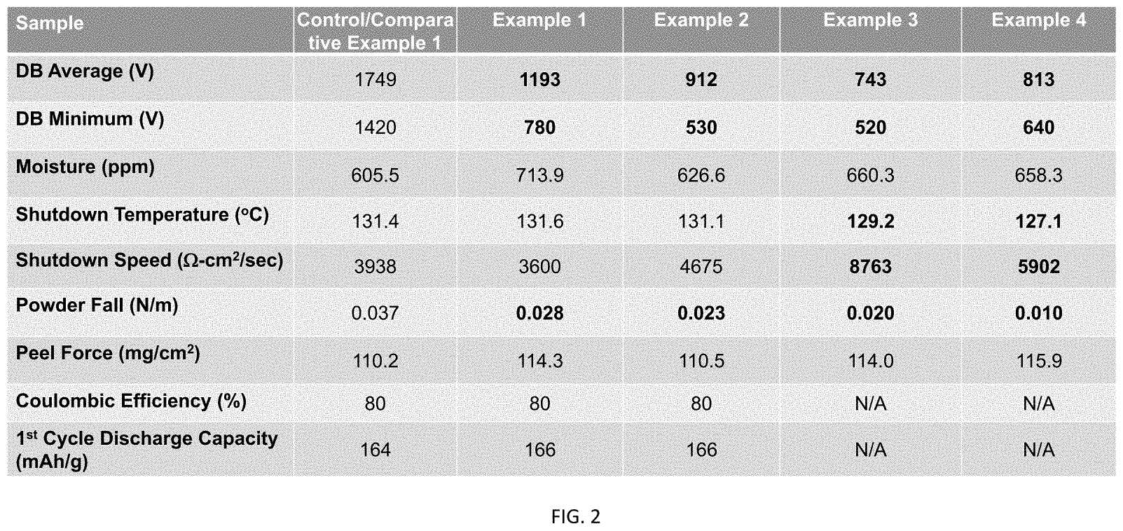

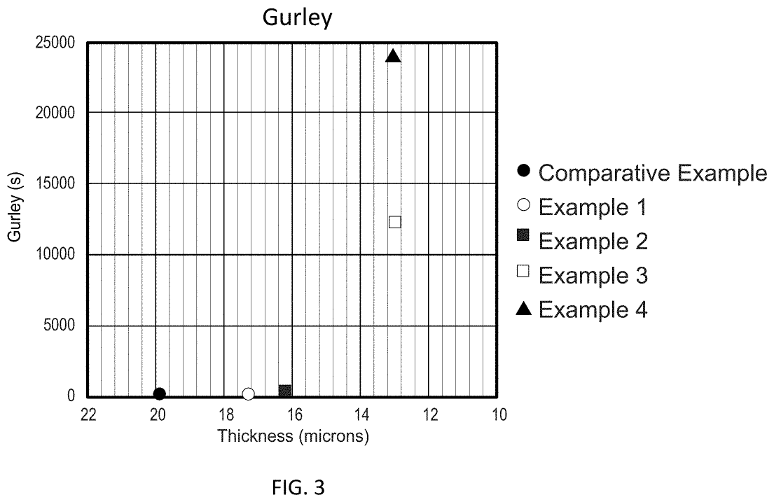

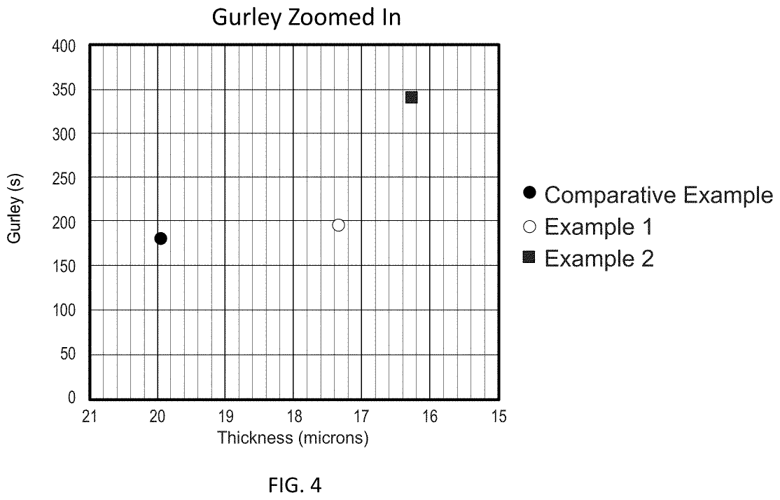

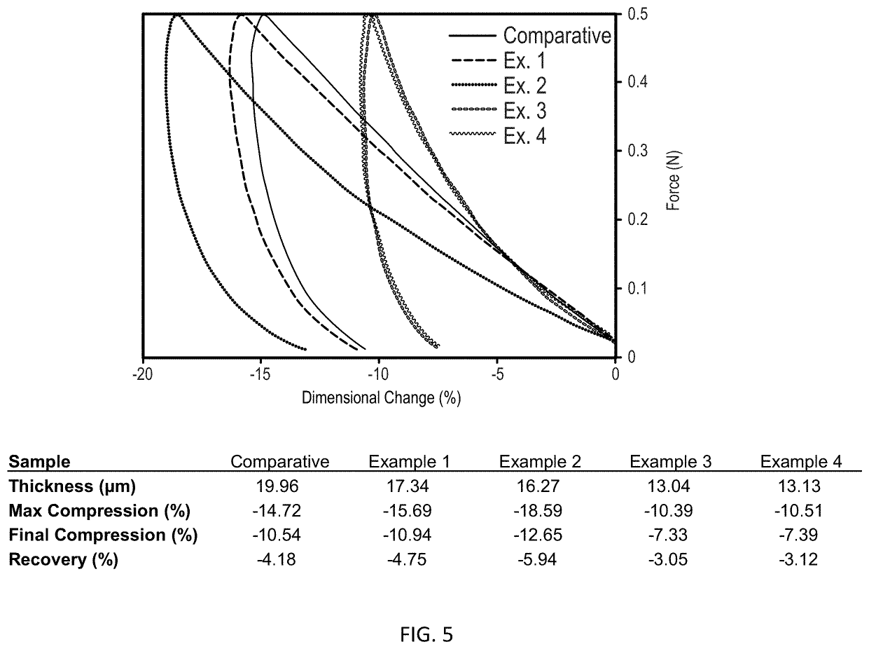

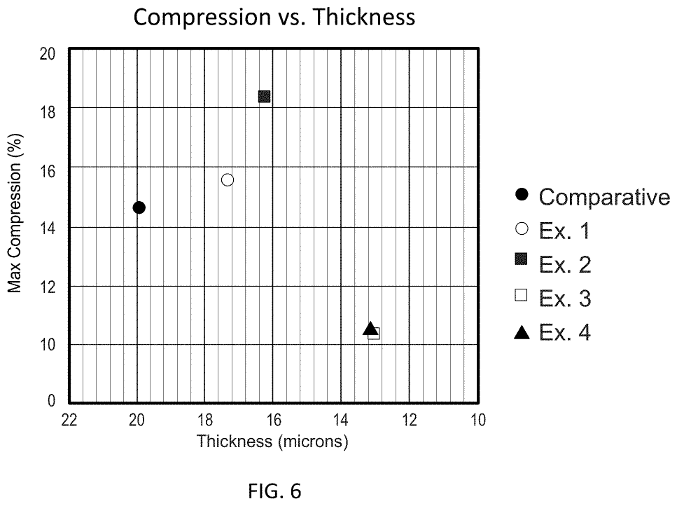

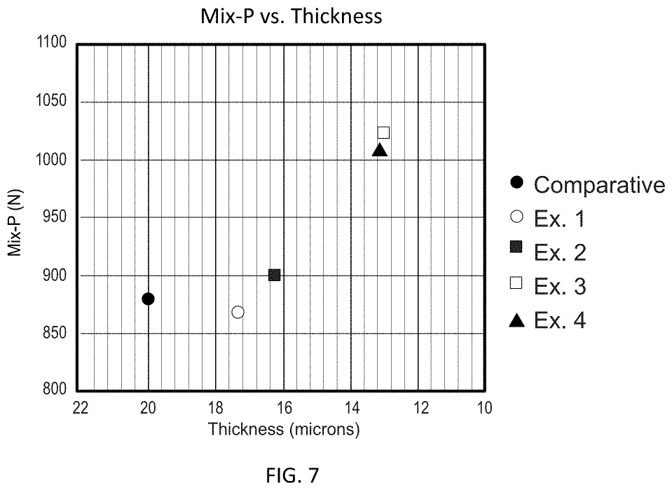

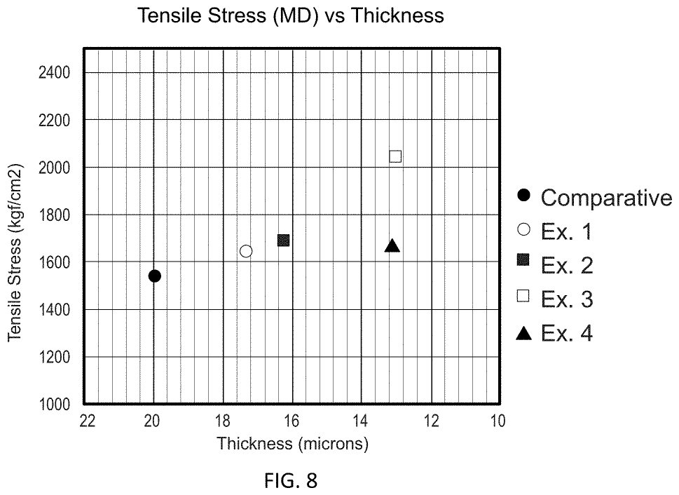

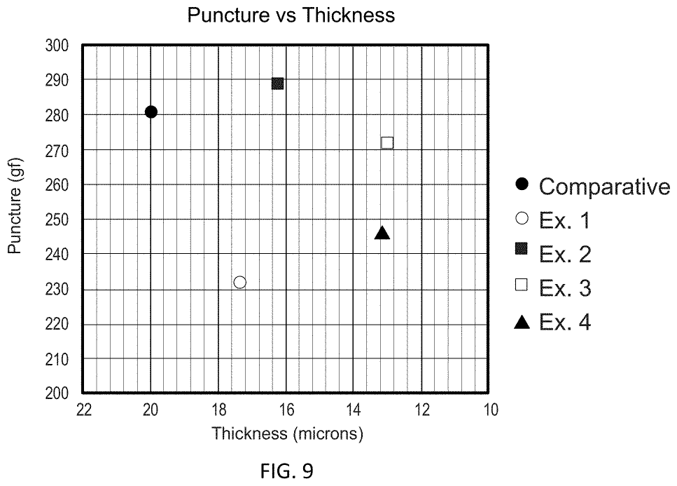

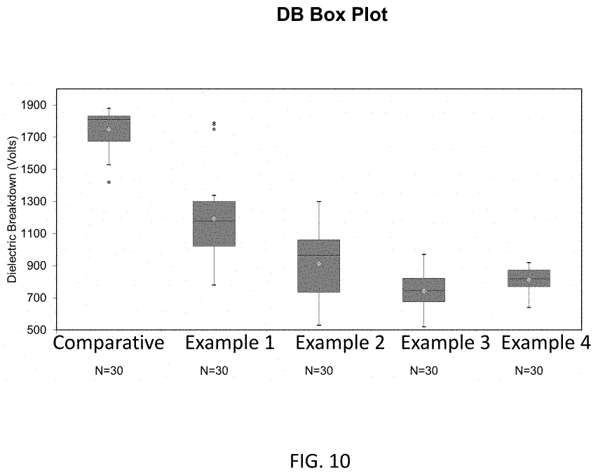

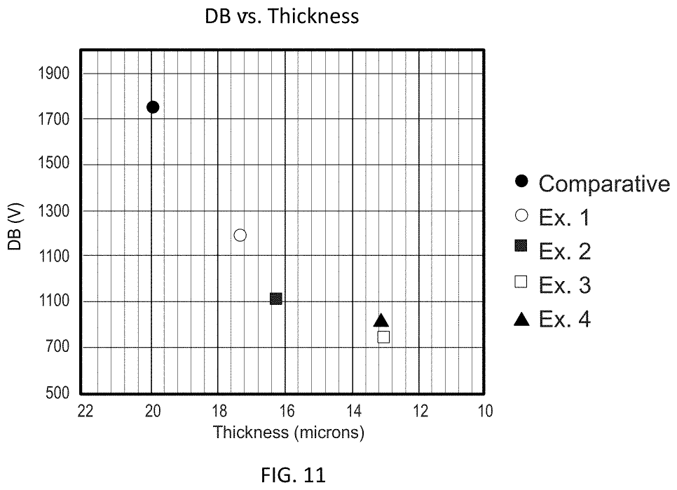

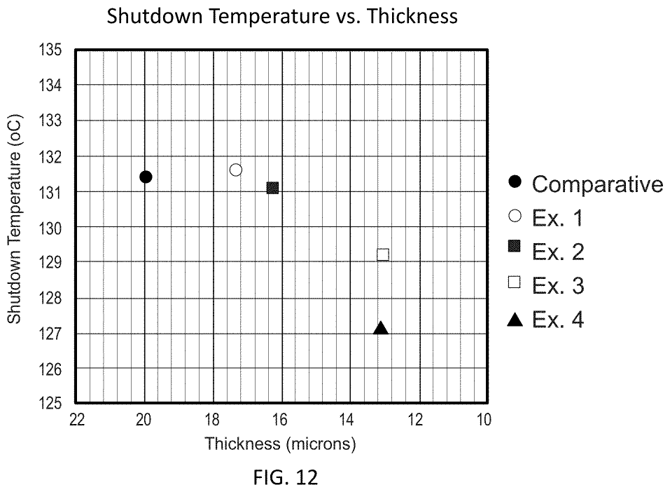

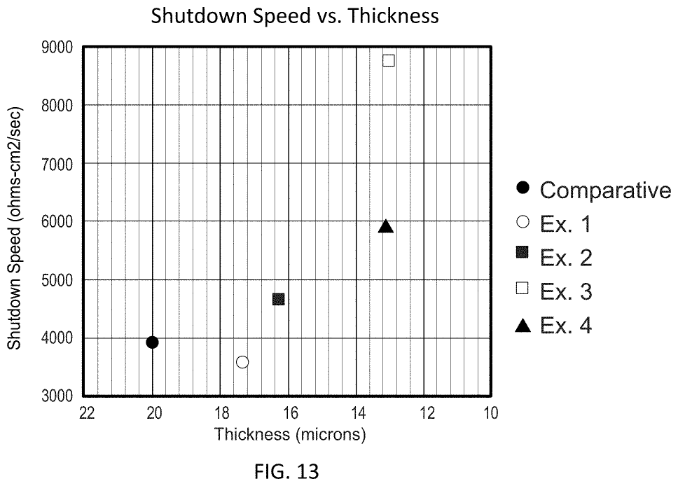

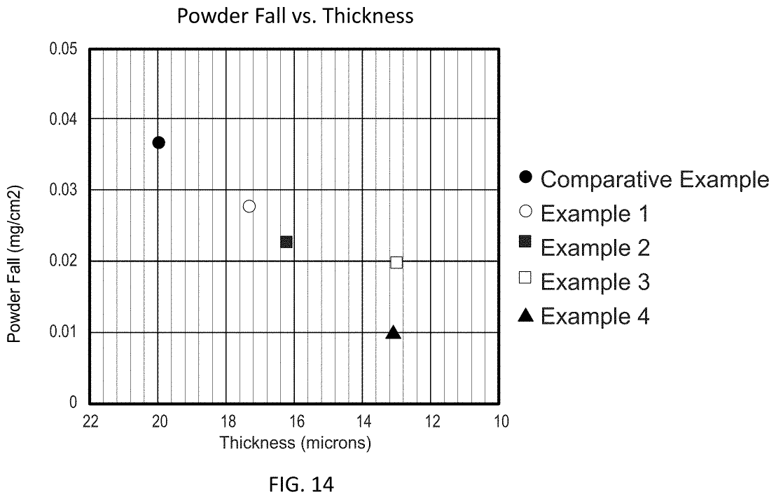

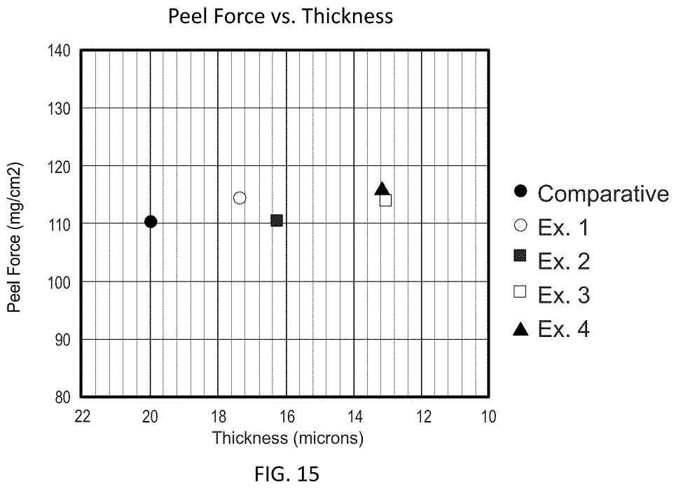

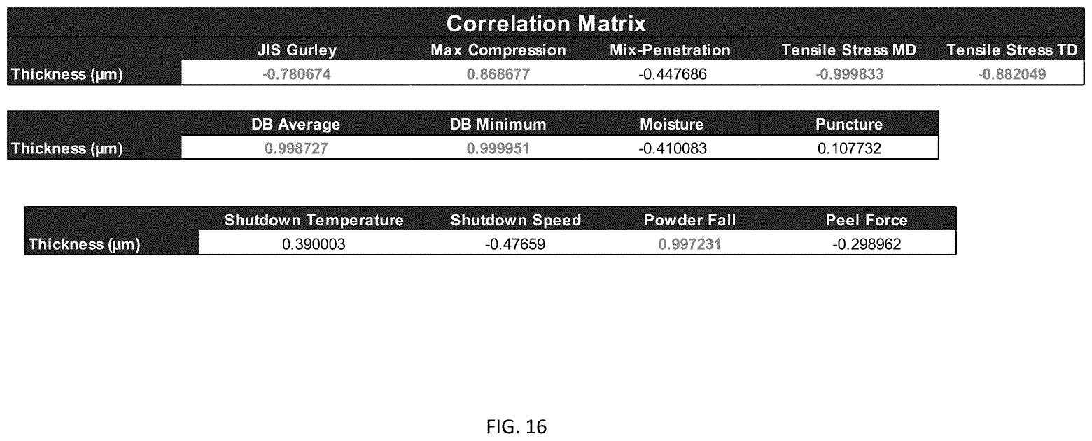

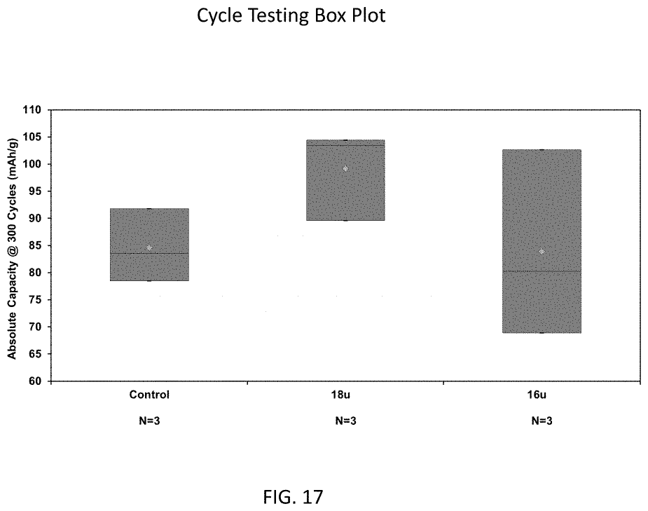

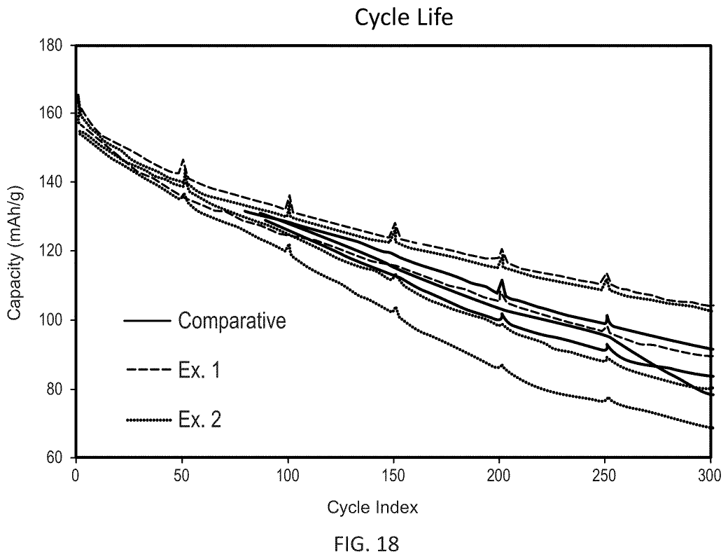

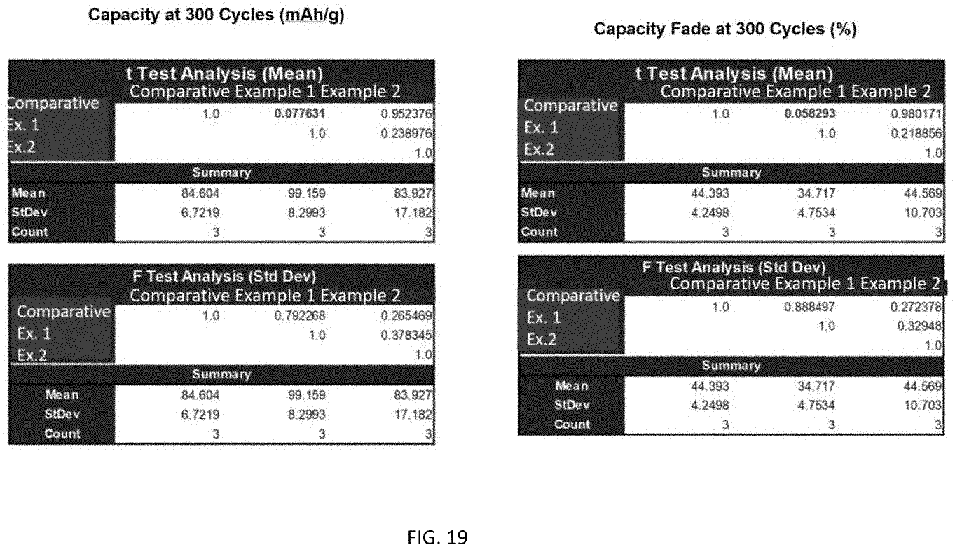

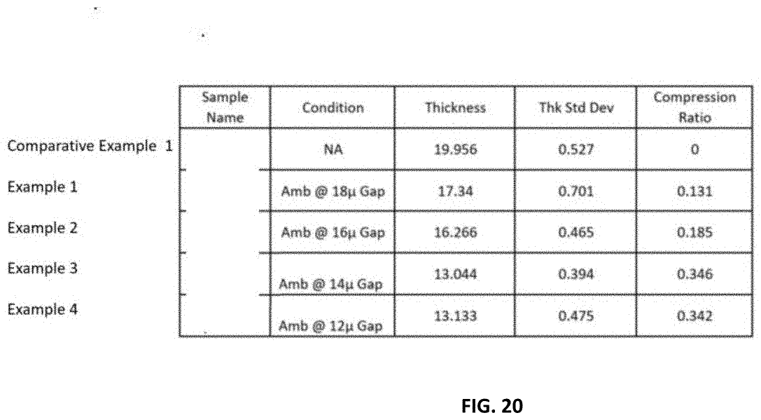

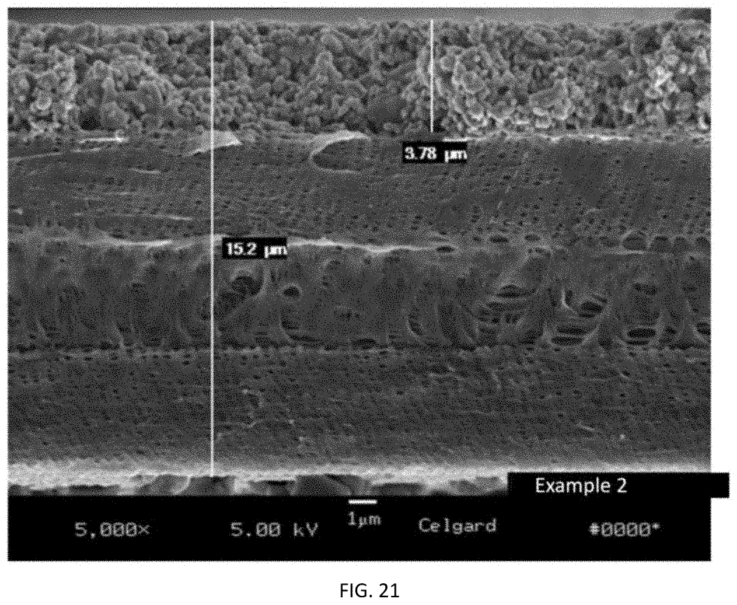

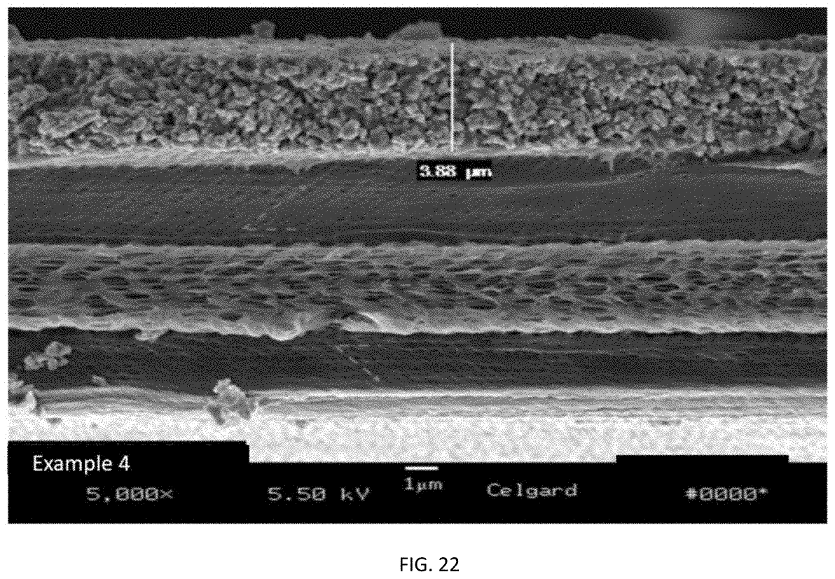

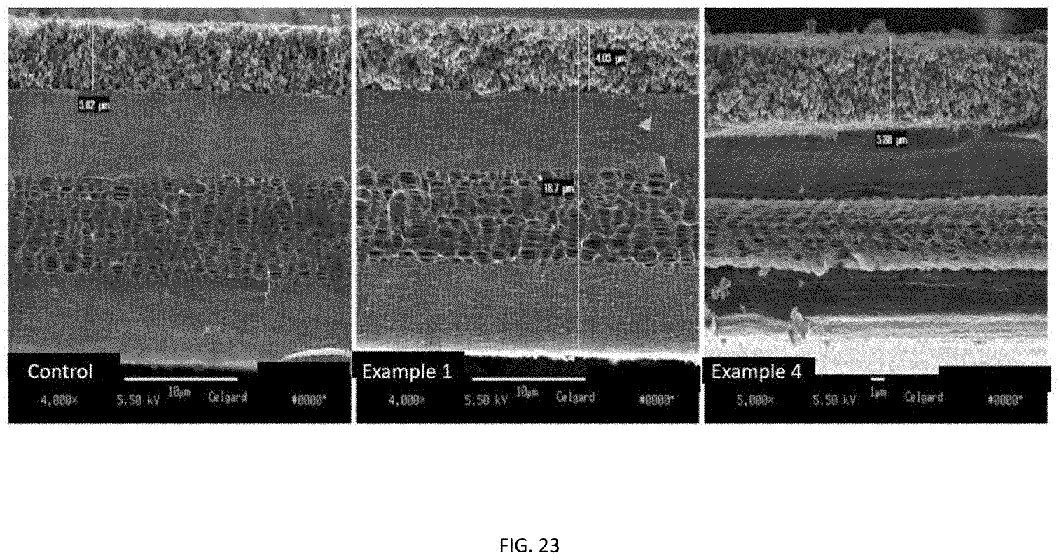

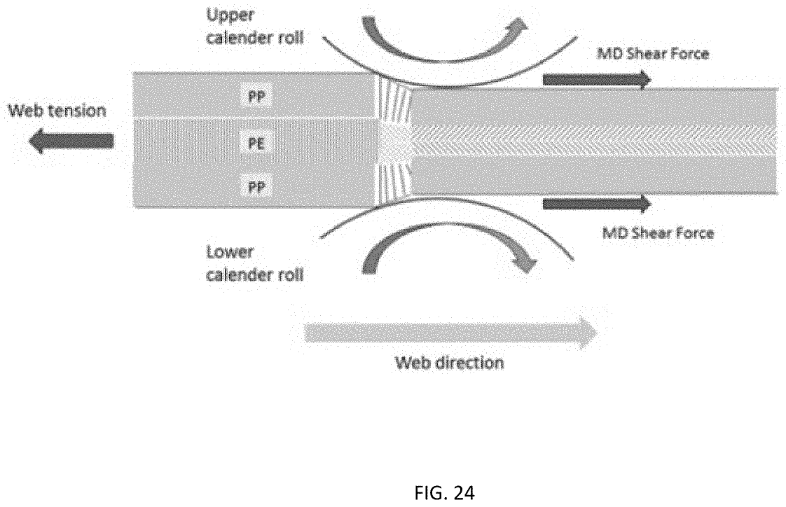

Comparative or Control Example—coated, but not calendered (control). A trilayer was coated with a 4 micron coating.
Example 1—Same as comparative Example, except coated and then additionally calendered at 18μ gap.
Example 2—Same as comparative Example, except coated and then additionally calendered at 16μ gap.
Example 3—Same as comparative Example, except coated and then additionally calendered at 14μ gap.
Example 4—Same as comparative Example, except coated and then additionally calendered at 12μ gap.
Example 5—Same as comparative Example, except coated and then additionally calendered at 10μ gap.
Example 6—Same as comparative Example, except coated and then additionally calendered at 9μ gap.
Results of testing performed on these Examples are found in FIGS. 1-23. High Gurley values for inventive samples (see FIGS. 3 and 4), without wishing to be bound by any particular theories are believed to be due to pore structure collapsing as the pressure increases to reduce the thickness when calendering. As shown in FIG. 7, the thinner separators have a higher mixed-P, when typically, thicker separators would have a higher mixed-p. Without wishing to be bound by any particular theory, it is believed this is due to the more altered pore structure in the thinner products. As shown in FIGS. 12 and 13, the shutdown temperature decreases and the shutdown speed increases with decreasing thickness. As shown in FIG. 15, peel force is not significantly affected by calendering. However, the amount of coating that comes off with rubbing the film is reduced as the calendered thickness decreases. As shown in FIGS. 17 and 18, the thicker calendered samples performed better than a thinner sample and the control in cycling tests. DB average (V) and minimum (V) was found to drop between the comparative and inventive Examples, but this is not unexpected due to the decreased thickness of the inventive films. FIGS. 21 to 23 show cross-section SEMs of some Examples described herein. For example, the cross-section SEMs show that calendering can, in some instances, result in a product having angled pores. See the SEMs of Examples 2 and 4. FIG. 24 shows a film web going through calendering rolls, which are designated by the curved arrows.

1. A method of forming a thin or ultrathin coated separator comprising:
forming a coating on a porous membrane to form a coated porous membrane; and
calendering the coated porous membrane to obtain a calendered and coated porous membrane, wherein the thin or ultrathin coated separator comprises, consists of, or consists essentially of the calendered and coated porous membrane.

2. The method of claim 1, wherein calendering is performed after the coating dries.

3. The method of claim 1, wherein a coating is formed on one or both sides of the porous membrane.

4. (canceled)

5. (canceled)

6. The method of claim 3, wherein a coating is formed on both sides of the porous membrane, and the coatings may be the same or different.

7. (canceled)

8. (canceled)

9. The method of claim 1, wherein the coating is or comprises at least one selected from the group consisting of a ceramic coating, a polymer coating, a shutdown coating, a sticky coating, and combinations thereof.

10. The method of claim 9, wherein the coating is or comprises a ceramic coating.

11. The method of claim 10, wherein the ceramic coating comprises, consists of, or consists essentially of ceramic and a binder.

12. The method of claim 10, wherein the ceramic coating comprises, consists of, or consists essentially of 60% or more ceramic, 70% or more ceramic, 80% or more ceramic, 90% or more ceramic, or 95% or more ceramic based on the total coating solids.

13. (canceled)

14. (canceled)

15. (canceled)

16. The method of claim 1, wherein calendering is performed by placing a calender in direct or indirect contact with the coating.

17. (canceled)

18. (canceled)

19. The method of claim 1, wherein calendering is performed by applying a pressure of 50 to 700, 50 to 600, 100 to 500, 100 to 400, 100 to 300, or 100 to 200 pounds per linear inch (PLI).

20. The method of claim 1, wherein the coated battery separator is thin and has a thickness less than or equal to 18 microns, less than or equal to 16 microns, less than or equal to 14 microns, or less than 12 microns and as low as 1 micron.

21. The method of claim 1, wherein the coated battery separator is ultrathin and has a thickness less than or equal to 11 microns, less than or equal to 10 microns, or less than 9 microns and as low as 1 micron.

22. The method of claim 1, wherein the formed coating, before calendering, has a thickness of from 0.5 to 10 microns or from 1 to 5 microns.

23. The method of claim 1, wherein the porous membrane is a microporous membrane, a wet process porous membrane, a dry process porous membrane, or a dry-stretch process porous membrane.

24. (canceled)

25. (canceled)

26. (canceled)

27. (canceled)

28. A coated battery separator made by the method of claim 1.

29. A secondary battery comprising the coated battery separator of claim 28.

30. A coated battery separator comprising, consisting of, or consisting essentially of a porous membrane with a coating on at least one side thereof, wherein the coated separator exhibits at least one of improved thickness uniformity of the coating, improved adhesion of the coating to the porous membrane, increased mixed-p(N), reduced amount of coating that comes off with rubbing, increased MD tensile stress (kgf/cm²), and increased TD tensile stress (kgf/cm²).

31. The coated battery separator of claim 30, wherein the porous membrane is a microporous membrane, a wet process porous membrane, a dry process porous membrane, or a dry-stretch process porous membrane.

32. (canceled)

33. The coated battery separator of claim 30, wherein the coated separator exhibits both improved thickness uniformity of the coating and improved adhesion of the coating to the porous membrane.

34. (canceled)

35. (canceled)

36. The coated battery separator of claim 30, wherein the coated separator is ultrathin and has a thickness less than or equal to 11 microns, less than or equal to 10 microns, or less than 9 microns and as low as 1 micron.

37. The coated battery separator of claim 30, wherein the coated separator is thin and has a thickness less than or equal to 18 microns, less than or equal to 16 microns, less than or equal to 14 microns, or less than 12 microns and as low as 1 micron.

38. The coated battery separator of claim 30, wherein the coating comprise, consists of, or consists essentially of a ceramic coating, a polymer coating, a shutdown coating, a sticky coating, or combinations thereof.

39. A secondary battery comprising the thin or ultrathin battery separator of claim 30.

40. The coated battery separator of claim 30, wherein:
the coated separator exhibits increased mixed-p(N); or
the coated separator exhibits increased mixed-p(N), wherein the mixed-p(N) is greater than 850N, greater than 900N, greater than 950N, or greater than 1000N.

41. (canceled)

42. The coated separator of claim 30, wherein:
the coated separator exhibits increased MD tensile stress (kgf/cm²); or
the coated separator exhibits increased MD tensile stress (kgf/cm²), wherein the MD tensile stress is greater than 1600 kgf/cm² or greater than 2000 kgf/cm².

43. (canceled)

44. The coated separator of claim 30, wherein:
the coated separator exhibits increased TD tensile stress (kgf/cm²); or
the coated separator exhibits increased TD tensile stress (kgf/cm²), wherein the TD tensile stress (kgf/cm²) is greater than 90, greater than 100, greater than 110, greater than 120, or greater than 130.

45. (canceled)

46. The coated battery separator of claim 30, wherein pores of the porous membrane are angled or tilted in a cross-section SEM of the coated battery separator.

47. The coated battery separator of claim 46, wherein the pores are angled in a direction that forms an acute angle with a surface of the porous membrane.

48. The coated battery separator of claim 30, wherein the porous membrane has angled or tilted pores as shown or described herein.

49. A method of forming a thin or ultrathin coated membrane comprising: forming a coating on a porous membrane to form a coated porous membrane; and
calendering the coated porous membrane to obtain a calendered and coated porous membrane, wherein the thin or ultrathin coated membrane comprises, consists of, or consists essentially of the calendered and coated porous membrane.

50. A coated membrane comprising, consisting of, or consisting essentially of a porous membrane with a coating on at least one side thereof, wherein the coated membrane exhibits at least one of improved thickness uniformity of the coating, improved adhesion of the coating to the porous membrane, increased mixed-p(N), reduced amount of coating that comes off with rubbing, increased MD tensile stress (kgf/cm²), and increased TD tensile stress (kgf/cm²).
